(19) United States
(12) Patent Application Publication
(10) Pub. No.: US 2006/0255556 A1
(43) Pub. Date: Nov. 16, 2006

(54) Leaf spring suspension systems and sub-assemblies therefor

(76) Inventor: John Bolland Reast, Bromham (GB)

Correspondence Address: Fildes & Outland, Suite 2, 20916 Mack Avenue, Grosse Point Woods, MI, 48236, US

(21) Appl. No.: 10/516,391

(22) PCT Filed: Jun. 14, 2002
(86) PCT No.: PCT/GB02/02476

§ 371 Date: Dec. 1, 2004

(51) Int. Cl. B60G 11/00

(52) U.S. Cl. 280/124.17; 280/124.175

(57) ABSTRACT

A sub-assembly and corresponding assembly method for a vehicle suspension system, comprising a leaf spring (22); a pair of mountings (26, 28; 39) located at respective fore and aft ends of the leaf spring (22) and adapted to be attached to the respective ones of a pair of fore and aft brackets (27, 41) secured to the frame (23) of an associated vehicle; and complementary means (40, 43) associated with the leaf spring (22) and with at least one of the fore and aft mountings (26, 28; 39) and adapted to permit adjustment of the free assembly length of the spring (22) between its fore and aft mountings (26, 28; 39) during assembly of the sub-assembly. Similar adjusting complementary means (36, 46) for the leaf spring (22) may also be provided at or adjacent the centre of the leaf spring (22) for mounting a transverse vehicle axle (34) thereto.

This invention relates to vehicle leaf spring suspension systems and sub-assemblies therefor.

Normally, when a pair of semi-elliptical leaf springs are used on a vehicle suspension system, the leaf springs locate the axle of the associated vehicle.

This is usually achieved by having an eye formed at one end, for example, the fore end, of each spring, which is fixed by a bush and bracket to the frame of the vehicle.

The axle is then fastened to each spring at or adjacent the longitudinal centre thereof. The axle is normally located to each spring by using a bolt which fastens the leaves of each spring together. This bolt usually has a dowel or round head which locates in a hole in the spring-to-axle seat on the axle and is normally called “the spring centre bolt”.

In normal quality spring manufacture, it is possible to maintain the dimensional relationship between the centre of the spring eye and the spring centre bolt to ±1.5 mm. This tolerance is also recommended in the Leaf Spring Design Manual of the Society of American Engineers (SAE HS 788 Chapter 2) and is a compromise between a tight, but reasonable, spring manufacturing tolerance and acceptable axle location and steering misalignment.

The other end, for example, the aft end, of each spring is manufactured to the same tolerance from the opposed spring eye and the spring centre bolt. Therefore, this other aft end location tolerance, relative to the fore end spring eye is twice the previous tolerance, namely, twice ±1.5 mm or ±3 mm. Again, this tolerance is recommended in the SAE HS 788 mentioned above.

The other or aft end of the spring supports the vehicle load into the vehicle frame, usually through a bracket.

Allowing for the additional tolerance between the bracket locations on the vehicle frame, the other or aft spring end-to-frame bracket has to be capable of accommodating a considerable positional tolerance.

There are many methods of supporting the load and accommodating this tolerance, for example, sliding cam-to-spring base brackets, rubber sheer-mount-base brackets or, more popularly, an eye and bush and a separate swinging shackle bracket into a bush at the frame bracket.

Having to accommodate this assembly tolerance is normally not a problem, because the same bracket assembly is also required to accommodate spring deflection and, hence, the change in horizontal length of each spring due to the curvature geometry thereof.

In certain applications, such spring tolerance is unacceptable, particularly when accurate positioning of the other, aft end of the spring relative to the eye at the fore end of the spring is required. Such has to be combined with an ability to have all leaves of each spring clamped to the other aft end bracket and, sometimes, an anti-roll stabiliser device, together with the ability to transmit any spring rate modifying moments into all the leaves of the spring.

Accordingly, it is an object of the present invention to provide a leaf spring suspension system and associated sub-assembly for a vehicle which overcome, or at least substantially reduce, the disadvantages associated with such assemblies, as discussed above.

In particular, an object of the invention is to provide a leaf spring suspension system and associated sub-assembly with very accurate end-to-end positional tolerances for the leaf springs for true assembly of the springs to a vehicle frame, with the leaves in each spring still being manufactured to normal current production tolerance standards. As only current manufacturing tolerances for leaf springs are required, suspensions in accordance with the invention avoid having to employ high precision and expensive manufacturing equipment and processes.

It is another object of the invention to provide a leaf spring suspension system, as well as an associated sub-assembly, which allows springs with several leaves to be clamped to the brackets of a vehicle frame at the second or aft spring end, without restricting relative leaf movements during operational leaf deflections. Any required spring rate-changing moment forces can also be transmitted into all, or at least some of, the leaves of the springs, as required.

Accordingly, a first aspect of the invention provides a sub-assembly for a vehicle suspension system, comprising:

a leaf spring;

a pair of mountings located at respective fore and aft ends of the leaf spring and adapted to be attached to respective ones of a pair of fore and aft brackets secured to the frame of an associated vehicle; and

complementary means associated with the leaf spring and with at least one of the fore and aft mountings and adapted to permit adjustment of the free assembly length of the spring between its fore and aft mountings during assembly of the sub-assembly.

Throughout this specification, the term “free assembly length” is used to define the distance between the fore and aft mountings of a leaf spring in its relaxed, unloaded condition.

Preferably, the complementary means for permitting adjustment of the free assembly length of the leaf spring between its fore and aft mountings, comprises an oversize aperture, such as a slot, in the leaf spring, through which aperture spring securing means, such as a clamping bolt, of the mounting extends.

The fore and/or aft mountings of the sub-assembly are used to mount the leaf spring to the frame of an associated vehicle either directly, for example, by means of brackets secured to the vehicle frame, or indirectly, for example, via an anti-roll device, such as an anti-roll bar or tube, extending transversely of the vehicle.

Additionally, the sub-assembly may comprise another mounting provided at or adjacent the centre of the leaf spring for mounting a transverse axle of the associated vehicle thereto. Such axle mounting and the leaf spring may also have complementary means arranged to permit adjustment of the free assembly length of the leaf spring during assembly of the sub-assembly. In this arrangement of sub-assembly, a multi-leaf spring is preferred, with complementary adjustment means being associated with one end of at least one of the spring leaves and the corresponding fore or aft mounting and additional complementary means being associated with another of the spring, leaves, generally centrally thereof, and the other mounting for an axle.

If the leaf spring comprises a single leaf, then only one complementary adjustment means need be provided at the fore or aft end thereof for co-operation with the corresponding fore or aft mounting of the sub-assembly.

Another aspect of the invention resides in a vehicle suspension system comprising:

a vehicle frame;

a pair of spaced brackets located on each side of the frame and secured thereto at respective fore and aft ends thereof; and

a pair of sub-assemblies comprising respective leaf springs each having a pair of mountings at respective fore and aft ends thereof and arranged on respective opposed sides, and extending longitudinally fore and aft, of the vehicle frame, with the fore and aft mountings of the springs being attached to respective ones of the fore and aft frame brackets, and complementary means associated with each leaf spring and with at least one of the fore and aft spring mountings and adapted to permit adjustment of the free assembly length of each leaf spring between its fore and aft mountings during assembly of each sub-assembly and prior to the sub-assemblies being attached to the respective vehicle frame brackets.

Preferably, the complementary means of each sub-assembly for permitting adjustment of the free assembly length of each leaf spring between its fore and aft mountings comprises an oversize aperture, such as a slot, in each leaf spring, through which aperture spring securing means, such as a clamping bolt, of the mounting extends.

The fore and/or aft mountings mount each leaf spring to the vehicle frame either directly, for example, by means of brackets, or indirectly, for example, via an anti-roll device, such as an anti-roll bar or tube, extending transversely of the vehicle frame.

Additionally, another mounting may be provided at or adjacent the centre of each leaf spring and such mounting and each leaf spring may also have complementary means adapted to permit adjustment of the free assembly length of each leaf spring during assembly of each sub-assembly of the suspension system. In this case, the other mountings are or can be used to mount the leaf springs to respective opposed ends of an axle extending transversely of the vehicle frame.

If each leaf spring comprises a single leaf, then any oversize aperture, through which a clamping bolt or other spring securing means extends, is provided in each single leaf at only one end thereof.

If, however, each leaf spring is multi-leaf and thus comprises at least two leaves, then such an oversize aperture may be provided in at least one, and preferably one, of the leaves of each spring at a fore or aft end thereof. With a centrally located axle mounting for each multi-leaf spring, an oversize aperture may be provided in another of the leaves.

A further aspect of the invention provides a method of assembling a sub-assembly for a vehicle suspension system, wherein the sub-assembly comprises:

a leaf spring;

a pair of mountings located at respective fore and aft ends of the leaf spring; and

complementary means associated with the leaf spring and with at least one of the fore and aft mountings for adjusting the free assembly length of the spring between its fore and aft mountings, and

wherein the method comprises:
manoeuvering the leaf spring generally longitudinally with respect to said at least one of its fore and aft mountings until the free assembly length of the spring between its fore and aft mountings is determined accurately; and
securing the spring and mounting together to maintain the so-determined free assembly length of the spring with the assembled sub-assembly.

The sub-assembly may include another mounting for an axle located at or adjacent the centre of the spring, in which case, further complementary means associated with the leaf spring and with the other, axle mounting may be provided, whereby, during assembly of the sub-assembly, the leaf spring can also be manoeuvered generally longitudinally with respect to such mounting until the free assembly length of the spring between its fore and aft mountings is determined accurately.

Again, such means may comprise an oversize aperture in the or at least one of the leaves of the spring generally centrally thereof and a bolt of the mounting extending through that aperture to allow relative longitudinal movement of the leaf or leaves with respect to the mounting during assembly of the sub-assembly and determination of the free assembly length of the spring between its fore and aft mountings. Once that length has been determined accurately, the mounting is secured tightly to the leaf spring, for example, by tightening the mounting bolt, thereby, along with the secured fore or aft end of the spring and corresponding mounting, maintaining the so-determined free assembly length of the spring in the assembled sub-assembly.

Subsequent to such assembly, the sub-assembly can be attached to one side of a vehicle frame by means of frame brackets, in a direct manner, or via, say, an anti-roll device extending transversely of the frame, in an indirect manner, and secured appropriately to the frame. Generally, a sub-assembly is attached to each side of a vehicle frame, with or without an associated transversely extending axle of the vehicle.

In order that the invention may be more fully understood, preferred embodiments of vehicle suspension system incorporating leaf spring suspension sub-assemblies assemblies and associated assembly methods in accordance therewith, will now be described by way of example and with reference to the accompanying drawings in which:

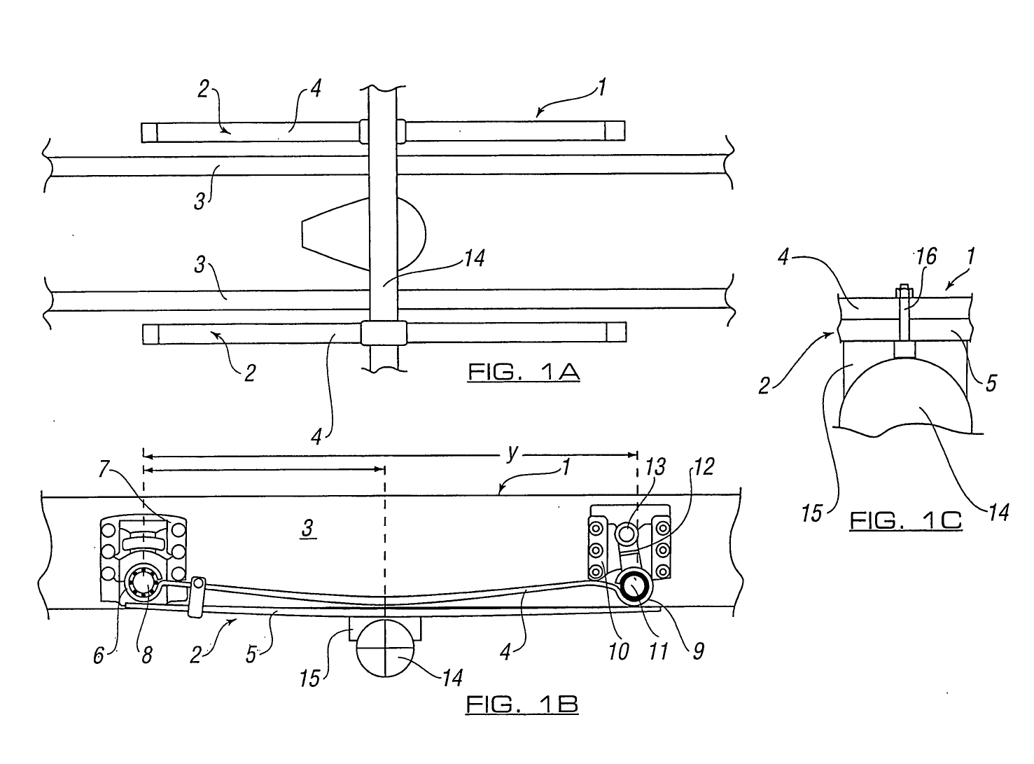

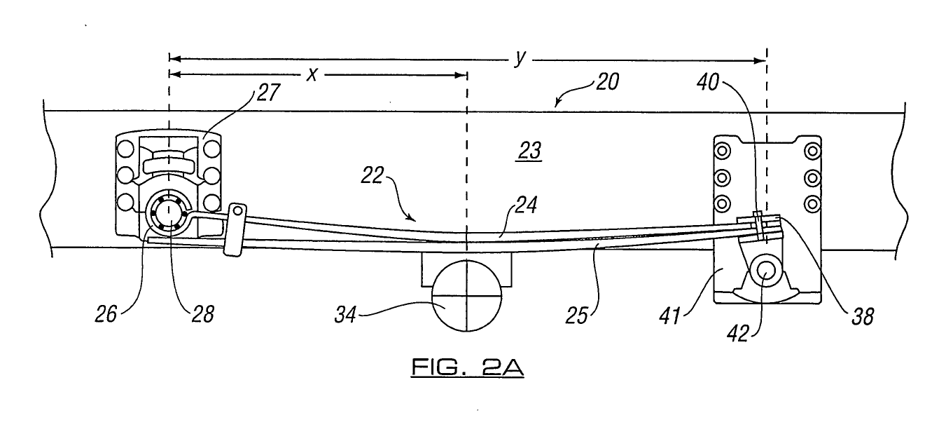

FIGS. 1A, 1B and 1C are respective plan, elevational and partial elevational views of a prior art leaf spring suspension;

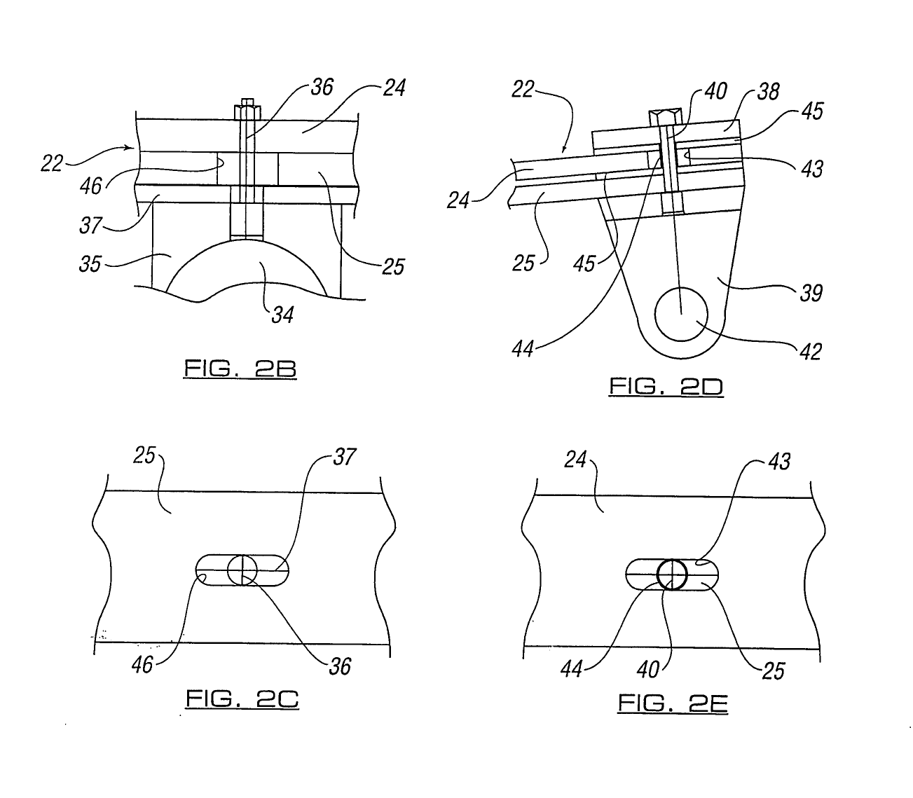

FIGS. 2A, 2B, 2C, 2D and 2E are respective elevational, partial elevational and partial plan views of a first embodiment of leaf spring suspension in accordance with the invention;

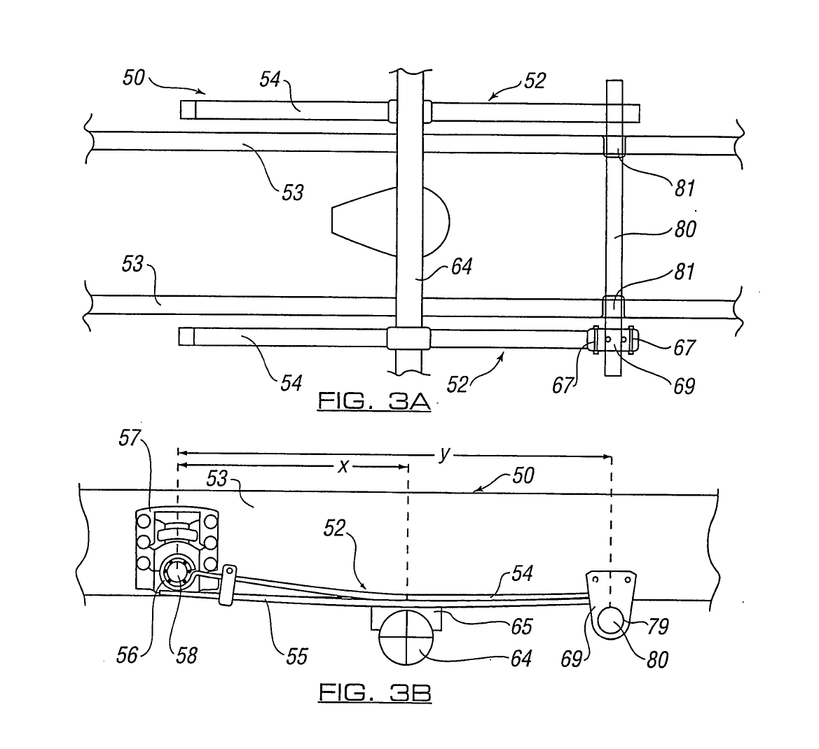

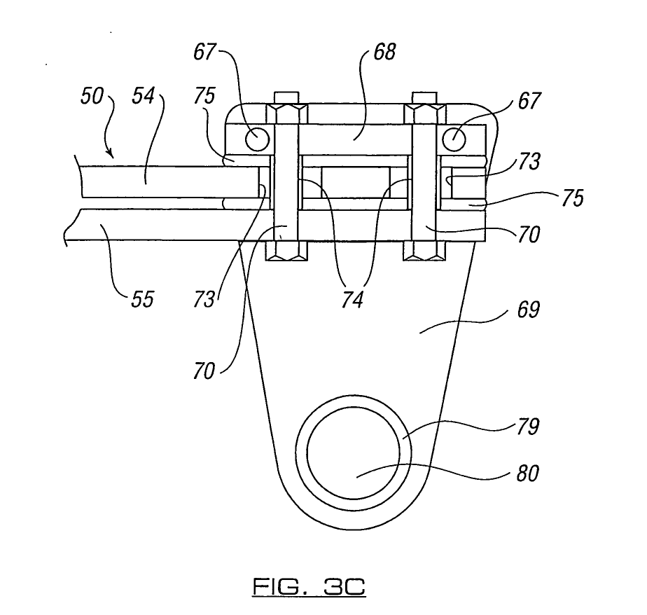

FIGS. 3A, 3B and 3C are respective plan, elevatidnal and partial elevational views of a second embodiment of leaf spring suspension in accordance with the invention;

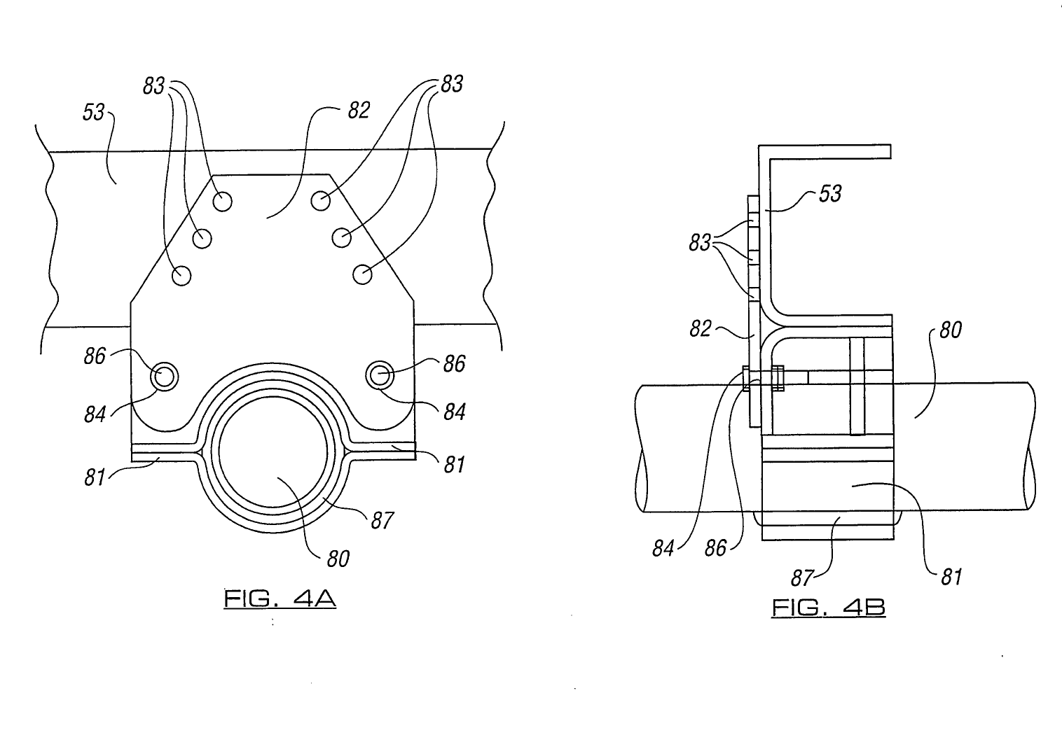

FIGS. 4A and 4B are respective partial perspective and elevational views of a third embodiment of leaf spring suspension in accordance with the invention;

FIG. 5 is a partial view of a fourth embodiment of leaf spring suspension in accordance with the invention; and

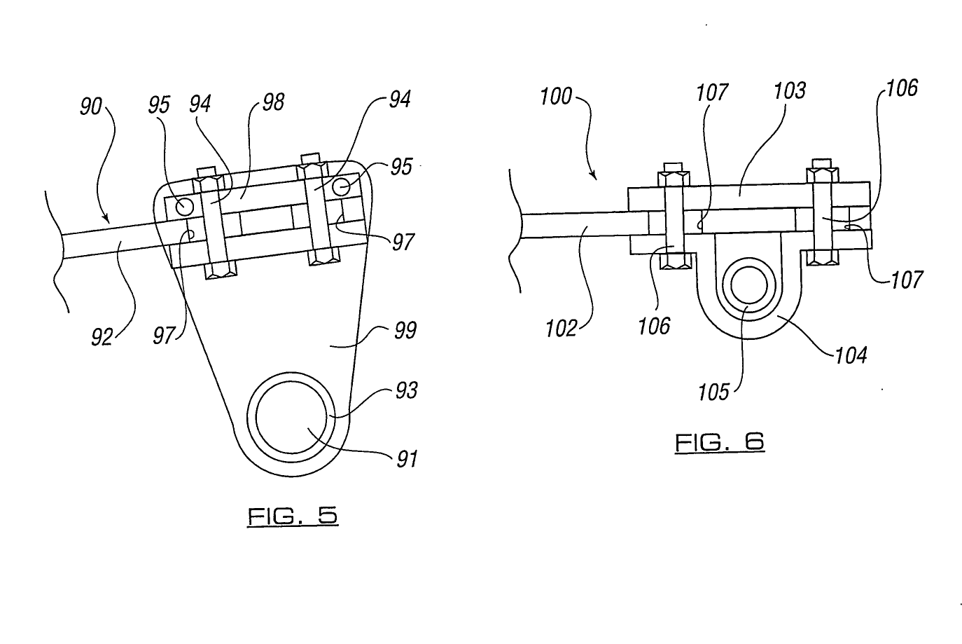

FIG. 6 is a partial elevational view of a fifth embodiment of leaf spring suspension in accordance with the invention.

Referring firstly to FIGS. 1A to 1C of the accompanying drawings, a prior art leaf spring suspension, indicated generally at 1, comprises a pair of leaf springs 2 located on respective opposed sides of the frame 3 of an associated vehicle (not shown) and extending longitudinally fore-and-aft thereof.

Each leaf spring 2 comprises an upper, first leaf 4 and a lower, second leaf 5.

The fore end of each first leaf 4, in the direction of travel of the associated vehicle, is formed with an eye 6 which is mounted to a fore end frame bracket 7 via a bush 8.

The aft end of each first leaf 4 is also formed with an eye 9 which is mounted to an aft end bracket 10 via a bush 11 and a swinging shackle 12 attached to the bracket 10 via another bush 13.

An axle 14 of the associated vehicle is mounted transversely thereof to each leaf spring 2 by means of an axle seat 15 and a spring centre bolt 16 passing through respective in-register bores in the upper first and lower second leaves 4, 5 of each spring 2.

In this prior art leaf spring suspension 1, typical, and recommended, good practice tolerances óx, óy for the free assembly length of each spring 2 determined by the distance x between the centre of each fore first leaf eye 6 and its spring centre bolt 16 but more specifically by the distance y between the centres of each fore and aft first leaf eyes 6, 9, are ±1.5 mm for óx and ±3.0 mm for óy.

During assembly of the suspension 1 to the vehicle frame 3, a sub-assembly is assembled for each side of the frame 3. Each sub-assembly comprises the leaf spring 2, the fore end bush 8, the aft end bush 11, shackle 12 and other bush 13, and optionally the axle 14 and axle seat 15. The free assembly length of each spring 2 is determined by the distance y between the centres of the fore and aft spring eyes 6 and 9 to a tolerance of óy=±3.0 mm.

Once that free assembly length of each spring 2 has been determined, each sub-assembly is attached to the respective pairs of fore and aft frame brackets 7 and 10.

Referring now to FIGS. 2A to 2E of the accompanying drawings, here is shown generally at 20 a first embodiment of leaf spring suspension in accordance with the invention.

This first embodiment of suspension 20 is similar to the prior art suspension 1 discussed above in relation to FIGS. 1A to 1C, in that it comprises a pair (only one shown) of leaf springs indicated generally at 22, comprising an upper, first leaf 24 and a lower, second leaf 25, with a fore eye 26 of the first leaf 22 being mounted to the vehicle frame 23 via a bush 28 attached to a fore frame bracket 27. Also, the central region of the leaf spring 22 has mounted thereto an axle 34 by means of an axle seat 35, a spacer 37 and a spring centre bolt 36.

However, the aft ends of the first and second leaves 24, 25 of each leaf spring 22 are mounted to the vehicle frame 23 by means of a clamp plate 38 and a bracket 39, with the aft ends of the leaves 24, 25 secured therebetween by means of a bolt 40.

In turn, each bracket 39 is attached to an aft fastening bracket 41 by means of a bush 42, with the bracket 41 being bolted to the vehicle frame or chassis 23.

This first embodiment of leaf spring suspension 20 requires a higher or tighter tolerance, 6y, for y than that provided in the prior art suspension 1 of FIG. 1 but because there is no shackle at the aft end of each leaf spring 22, there is no apparent provision for accommodating higher tolerances.

However, a higher tolerance óy for y, namely, the free assembly length of each spring 22, of, say, ±1.5 mm between the centres of the fore and aft bushes 28, 42 can be achieved with this first embodiment of leaf spring suspension 20. Indeed, higher tolerances \acute{o}y than ±1.5 mm for y can be achieved if required.

Thus, and in accordance with the invention, the aft end of each first leaf 24 is provided with an oversize hole in the form of a longitudinally-extending slot 43 through which the bolt 40 extends via a cylindrical spacer 44. The bolt 40 also passes through correspondingly-dimensioned bores in the clamp plate 38 and second leaf 25, in conventional manner, namely tightly.

Suitable spacers 45, such as those of compressed rubber or polymeric material, possibly compression pre-loaded, are provided between the clamp plate 38 and upper surface of the first leaf 24 and between the respective lower and upper surfaces of the first and second leaves, 24, 25, again in fairly conventional manner.

In a similar manner, at the central region of each leaf spring 22, the lower, second leaf 25 is also provided with a slot 46 through which the spring centre bolt 36 extends, although here no bolt spacer is used.

With these bolts 36, 40 and slots 46, 43, suitable adjustments to the free assembly lengths y of the leaves 24, 25 of each spring 22 can be made during assembly of the suspension to an associated vehicle, to provide a higher tolerance for y than that capable of being provided by the prior art suspension 1 discussed in relation to FIG. 1 above.

Indeed, such adjustments are made to a sub-assembly for each side of the vehicle frame 23, each sub-assembly being assembled from the leaf spring 22, the fore bush 28, the aft clamp plate 38, bracket 39, bolt 40, spacers 45 and bush 42, as well as the centre bolt 36 and spacer 37 and, optionally, the axle 34 and axle seat 35. Before the sub-assembly is attached to the vehicle frame 23 via the fore and aft frame brackets 27, 41, the upper, first leaf 24 and lower, second leaf 25 are manoeuvered generally longitudinally of each other, with the spring centre bolt 36 and aft spring bolt 40 loosened and, in cooperation with respective slots 46, 43, thus permitting such generally longitudinal movement of the spring leaves 24, 25 with respect to each other. When the free assembly length y of each spring 22 has been determined to within a tolerance óy of ±1.5 mm in such a manner, the bolts 36, 40 are tightening, thereby maintaining that length y between the centres of the fore and aft bushes 28, 42.

Thereafter, each sub-assembly is mounted to the vehicle frame 23 by being secured to the fore and aft brackets 27, 41 which are already secured by bolts to the frame 23.

Turning now to FIGS. 3A to 3C of the accompanying drawings, here is shown generally at 50 a second embodiment of leaf spring suspension in accordance with the invention.

This second embodiment of assembly 50 is similar to the prior art assembly 1 described above in relation to FIGS. 1A to 1C, in that is comprises a pair of leaf springs, indicated generally at 52, each with an upper, first leaf 54 and a lower, second leaf 55, with a fore eye 56 of the first leaf 52 being mounted to the vehicle frame or chassis 53 via a bush 58 attached to a fore frame bracket 57. Also, the central region of the leaf spring 52 has mounted thereto an axle 64 by means of an axle seat 65, a spacer (not shown) and a spring centre bolt (also not shown).

The aft ends of the first and second leaves 54, 55 of each leaf spring 52 are mounted to a clamp plate 68 and a fastening bracket 69, with the aft ends of the leaves 54, 55 being secured therebetween by a pair of bolts 70 spaced longitudinally of the leaf springs 52. Each fastening bracket 69 is secured to its corresponding clamp plate 68 by means of a pair of bolts 67.

Each fastening bracket 69 is attached to the vehicle frame or chassis 53 by means of a transversely-extending anti-roll bar or tube 80. At each outboard end of the anti-roll bar or tube 80, the corresponding bracket 69 is welded thereto at 79, whilst each inboard end of the anti-roll bar or tube 80 is mounted beneath and to the vehicle frame 53 by means of an aft, stabiliser bar or tube bracket 81. In this manner, the aft ends of the leaf springs 52 can be mounted to the vehicle frame 53, as will be described in more detail hereinbelow.

Each pair of through bolts 70 resist the additional stabilising movements which are transmitted into the leaf springs 52 from the anti-roll bar or tube 80 during use.

As in the case of the first embodiment of leaf spring suspension 20 described above, this second embodiment of leaf spring suspension 50 requires a higher or tighter tolerance, óy, for y than that afforded by the prior art suspension 1 of FIG. 1 but, again, because there is no shackle at the aft end of each leaf spring 52, there is no apparent provision for accommodating such higher tolerances óy.

However, a higher tolerance óy for y of, say, ±1.5 mm, between the centre of the fore end bush 58 and aft bracket 69 can be achieved with this second embodiment of leaf spring suspension 50. Higher tolerances óy than +1.5 mm for y can be achieved if required.

Thus, and in accordance with the invention, the aft end of each first leaf 54 is provided with a pair of oversize holes in the form of a pair of slots 73 through which respective bolts 70 extend via cylindrical spacers 74. Each bolt 70 also extends through correspondingly-dimensional bores in the clamp plate 68 and second leaf 55, in conventional manner, namely tightly.

Suitable spacers 75, such as rubber spacers, preferably compression preloaded, are provided between the clamp plate 68 and upper surface of the first leaf 54 and between respective lower and upper surfaces of the first and second leaves 54, 55.

Again, and as in the case of the first embodiment described above, the central region, and preferably the centre, of the leaf spring 52 is mounted to the axle 64 in a manner similar to that of the first embodiment, namely by means of a bolt extending through a slot in each lower, second leaf 55.

With this arrangement, adjustments to the leaves 54, 55 of each spring 52 can provide a higher tolerance óy for y, than those which can be provided by the prior art assembly 1 described above in relation to FIG. 1 above.

Again, such adjustments are made to a sub-assembly for each side of the vehicle frame 53, with each sub-assembly being assembled from a leaf spring 52, the fore end bush 58, the aft clamp plate 68, bracket 69, bolts 70, spacers 75 and anti-roll bar or tube 80, as well as an axle centre bolt and spacer as provided by the centre bolt 36 and spacer 37 of the first embodiment described above, and, optionally, the axle 64 and axle seat 35. Before each so-assembled sub-assembly is attached to the vehicle frame 53 via the fore bracket 57 and the anti-roll bar or tube 80, the upper, first leaf 54 and lower, second leaf 55 are manoeuvered generally longitudinally of each other, with the spring centre bolt (not shown) and aft spring bolts 70 loosened and, in cooperation with respective ones of the slot (not shown) in the lower, second leaf 55 and the slots 73 in the upper, first leaf 54, thus permitting such generally longitudinal movement of the spring leaves 54, 55 with respect to each other. When the free assembly length y of each spring 52 has been so-determined to within a tolerance óy of ±1.5 mm, the spring centre bolt and aft bolts 70 are tightened, to maintain that length y between the centres of the fore end bush 58 and the anti-roll bar or tube 80, which latter centre is effectively a virtual centre for the centre of each aft frame bracket 81.

Subsequently, each so-assembled sub-assembly is mounted to the vehicle frame 53 by being secured to the fore and aft brackets 57, 81.

In FIGS. 4A and 4B, there is shown a arrangement which could be used for mounting each sub-assembly to the vehicle frame 53 via the anti-roll bar or tube bracket 81 which is bushed at 87 and is associated with each end of the anti-roll bar or tube 80 and a frame bracket 82.

In this arrangement, each frame bracket 82 is bolted at 83 to the vehicle frame 53 and to the anti-roll bar or tube bracket 81 by a pair of bolts 84. The holes 86 through which the bolts 84 extend, may be oversize to accommodate frame assembly tolerances.

Indeed, the oversize holes 86 through which the bolts 84 extend, accommodate, in both vertical and horizontal directions, any errors in the construction of the frame 53 of the vehicle during assembly. For example, errors arising from distortions between frame assembly holes and surfaces during manufacture, can be accounted for by manoeuvering the anti-roll bar or tube bracket 81 with respect to the frame bracket 82 during assembly thereof before the securing bolts 84 are finally tightened.

Considering now the embodiment shown in FIG. 5, this could be used in a similar manner as that described above in relation to the second embodiment of suspension 50 of FIGS. 3A to 3C. Here, however, the leaf spring, indicated generally at 90, comprises a single leaf 92 whose rear end is mounted to the vehicle frame via a clamp plate 98 and a fastening bracket 99 which is, in turn, attached to an end of an anti-roll bar or tube 91 via a weld 93. The anti-roll bar or tube 91 is secured to the vehicle frame by means of its own bracket and an aft frame bracket (not shown) in a similar manner to the brackets 81 and 82 of the second embodiment of FIGS. 3A to 3C.

Clamping bolts 94 extend through corresponding holes in the clamp plate 98 and bracket 99, whilst the clamp plate 98 is mounted to the bracket 99 at 95.

The bolts 94 also extend through oversize holes in the form of slots 97 in the aft end of each single leaf 92, for adjustment of the free assembly length of the spring 90, as hereinbefore described with reference to the second embodiment of FIGS. 3A to 3C.

Referring now to a further embodiment shown in FIG. 6, this arrangement would be suitable for use with the first embodiment described above with reference to FIGS. 2A to 2E but for a leaf spring 100 having a single leaf 102.

Here, the aft end of each single leaf 102 is mounted to a vehicle frame by means of a clamp plate 103 and a bracket 104 via a bush 105. Clamping bolts 106 clamp the aft end of each single leaf 102 between the clamp plate 103 and bracket 104, with the bolts 106 passing through oversize holes in the form of slots 107 in the aft end of each single leaf 102.

It is to be appreciated that in the embodiments described above, the location of the attachment of the components of the suspensions to the axles and frames are discussed in detail. However, other features for such clamping attachment, such as U-bolts and the like, will also be required to provide the necessary and required strength of attachment for rigidity and transference of in-service loads to which the suspensions are subjected during use.

Further, it is to be understood that the order in which the sub-assemblies, as well as any sub-assemblies thereof, are given as examples in the embodiments described above but can be varied to suit production and other assembly requirements.

1. A sub-assembly for a vehicle suspension system, comprising:
a leaf spring;
a pair of mountings located at respective fore and aft ends of the leaf spring and adapted to be attached to respective ones of a pair of fore and aft brackets secured to the frame of an associated vehicle; and
complementary means associated with the leaf spring and with at least one of the fore and aft mountings and adapted to permit adjustment of the free assembly length of the spring between its fore and aft mountings during assembly of the sub-assembly.

2. A sub-assembly according to claim 1, wherein said complementary means for permitting adjustment of the free assembly length of the leaf spring between its fore and aft mountings, comprises an oversize aperture in the leaf spring, through which aperture spring securing means of the mounting extends.

3. A sub-assembly according to claim 2, wherein the oversize aperture comprises a slot and said spring securing means comprises a clamping bolt.

4. A sub-assembly according to claim 1, wherein the fore and aft mountings are adapted to mount the leaf spring to the frame of an associated vehicle directly.

5. A sub-assembly according to claim 4, wherein the leaf spring is adapted to be mounted to a vehicle frame by means of brackets secured to the vehicle frame.

6. A sub-assembly according to claim 1, wherein the fore and aft mountings are adapted to mount the leaf spring to the frame of an associated vehicle indirectly.

7. A sub-assembly according to claim 6, wherein the leaf spring is adapted to be, mounted to the vehicle frame via an anti-roll device extending transversely of the frame.

8. A sub-assembly according to claim 1 further comprising another mounting provided at or adjacent the center of the leaf spring for mounting a transverse axle of the associated vehicle thereto.

9. A sub-assembly according to claim 8, wherein the other, axle mounting and the leaf spring also comprise complementary means adapted to permit adjustment of the free assembly length of the leaf spring during assembly of the sub-assembly.

10. A sub-assembly according to claim 1, wherein the spring is a multi-leaf spring with complementary adjustment means being associated with one end of at least one of the spring leaves and the corresponding fore or aft mounting and additional adjustment means being associated with another of the spring leaves, generally centrally thereof, and the other mounting for an axle.

11. A sub-assembly according to claim 1, wherein the leaf spring comprises a single leaf, with only one complementary adjustment means provided at the fore or aft end thereof for co-operation with the corresponding fore or aft mounting of the sub-assembly.

12. (canceled)

13. A vehicle suspension system comprising:
a vehicle frame;
a pair of spaced brackets located on each side of the frame and secured thereto at respective fore and aft ends thereof; and
a pair of sub-assemblies comprising respective leaf springs each having a pair of mountings at respective fore and aft ends thereof and arranged on respective opposed sides, and extending longitudinally fore and aft, of the vehicle frame, with the fore and aft mountings of the springs being attached to respective ones of the fore and aft frame brackets, and complementary means associated with each leaf spring and with at least one of the fore and aft spring mountings and adapted to permit adjustment of the free assembly length of each leaf spring between its fore and aft mountings during assembly of each sub-assembly and prior to the sub-assemblies being attached to the respective vehicle frame brackets.

14. A system according to claim 13, wherein said complementary means of each sub-assembly for permitting adjustment of the free assembly length of each leaf spring between its fore and aft mountings comprises an oversize aperture in each leaf spring, through which aperture spring securing means of the mounting extends.

15. A system according to claim 14, wherein the oversize aperture comprises a slot in each spring and said spring securing means comprises a clamping bolt.

16. A system according to claim 13, wherein the fore and aft mountings mount each leaf spring to the vehicle frame brackets directly.

17. A system according to claim 13, wherein each leaf spring is mounted to one of the vehicle frame brackets indirectly via an anti-roll device, such as an anti-roll bar or tube, extending transversely of the vehicle frame.

18. A system according to claim 13, wherein another mounting is proved at or adjacent the center of each leaf spring, such mounting and each leaf spring having associated complementary means adapted to permit adjustment of the free assembly length of each leaf spring during assembly of each sub-assembly of the suspension system.

19. A system according to claim 18, wherein the other mountings mount the leaf springs to respective opposed ends of an axle extending transversely of the vehicle frame.

20. A system according of claim 13, wherein each leaf spring comprises a single leaf, with an oversize aperture through which a clamping bolt or other spring securing means extends, provided in each single leaf at only one end thereof.

21. A system according to claim 14, wherein each leaf spring is multi-leaf with an oversize aperture provided in at least one, and preferably only one, of the leaves of each spring at a fore or aft end thereof, and with an oversize aperture provided in another of the leaves at the centrally located axle mounting.

22. A vehicle suspension system according to claim 13, wherein the securement of at least one of each pair of the brackets located on each side of the vehicle frame is adjustable after or whilst the sub-assemblies have been or are being attached thereto.

23. A method of assembling a sub-assembly for a vehicle suspension system, wherein the sub-assembly comprises:
a leaf spring;
a pair of mountings located at respective fore and aft ends of the leaf spring; and
complementary means associated with the leaf spring and with at least one of the fore and aft mountings for adjusting the free assembly length of the spring between its fore and aft mountings, and
wherein the method comprises:
maneuvering the leaf spring generally longitudinally with respect to said at least one of its fore and aft mountings until the free assembly length of the spring between its fore and aft mountings is determined accurately; and
securing the spring and mounting together to maintain the so-determined free assembly length of the spring within the so-assembled sub-assembly.

24. A method according to claim 23, wherein the sub-assembly is provided with another mounting for axle located at or adjacent the center of the spring, with further complementary means associated with the leaf spring and with the other, axle mounting also being provided, whereby, during assembly of the sub-assembly, the leaf spring is also maneuvered generally longitudinally with respect to such mounting until the free assembly length of the spring between its fore and aft mountings is determined accurately.

25. A method according to claim 23, wherein said complementary means is provided with an oversize aperture in the or at least one of the leaves of the spring generally centrally thereof, a bolt of each mounting extends through that aperture and the leaf or leaves are maneuvered longitudinally with respect to the mountings during assembly of the sub-assembly, to determine the free assembly length of the spring between its fore and aft mountings.

26. A method according to claim 23, wherein, once the free assembly length of the spring has been determined accurately, the mounting is secured tightly to the leaf spring, for example, by tightening the mounting bolt, thereby, along with the secured fore or aft end of the spring and corresponding mounting, maintaining the so-determined free assembly length of the spring in the assembled sub-assembly.

27. A method according to claim 23, wherein, subsequent to assembly of the sub-assembly, the so-assembled sub-assembly is attached directly to one side of a vehicle frame by means of frame brackets.

28. A method according to claim 23, wherein, subsequent to assembly of the sub-assembly, the so-assembled sub-assembly is attached indirectly to one side of a vehicle frame via an anti-roll device extending transversely.0f the frame and secured to the frame.

29. A method according to claim 23, wherein a sub-assembly is attached to each side of a vehicle frame, with or without an associated transversely extending axle of the vehicle.

30. A method according to claim 29, wherein attachment of a so-assembled sub-assembly to each side of a vehicle frame is adjusted to take into account positional tolerances therebetween.

31. A method according to claim 30, wherein said adjustable attachment of a sub-assembly to each side of a vehicle frame is effected by means of a combination of bolts and oversize holes associated with each sub-assembly and the vehicle frame.
